(19) United States
(12) Patent Application Publication
(10) Pub. No.: US 2005/0194158 A1
(43) Pub. Date: Sep. 8, 2005

(54) Gardening tool

(76) Inventor: Jan Luik, Zaltbommel (NL)

Correspondence Address: YOUNG & THOMPSON, 745 SOUTH 23RD STREET, 2ND FLOOR, ARLINGTON, VA, 22202, US

(21) Appl. No.: 11/030,999

(22) Filed: Jan. 10, 2005

Related U.S. Application Data
(60) Provisional application No. 60/538,159, filed on Jan. 22, 2004.

(30) Foreign Application Priority Data
Jan. 9, 2004 (NL) 1025196

(51) Int. Cl. A01B 1/00

(52) U.S. Cl. 172/371

(57) ABSTRACT

A multi-functional gardening tool comprises a handle (4) with a handgrip (5) on a first outer end and a working member (1,2,3) on a second outer end. The working member comprises a first blade-like part (2) with which it is connected to the second outer end of the handle. The working member further comprises a second blade-like part (1) with a number of at least substantially parallel tines lying in a blade plane, which second part extends from the first part. The first and second blade-like parts of the working member together enclose an obtuse angle.

The present invention relates to a gardening tool comprising a handle with a handgrip on a first outer end and a working member on a second outer end.

There are many types and sizes of gardening tools for performing different work in and around the garden or the land. Characteristic here is that each operation usually has its own tool with a working member and a handle which are specifically adapted to that operation. A (leaf) rake is thus used to gather together loose parts, leaves or weeds and to level a ground surface and then lift the raked-together material with a shovel or a fork. With a fork any loose soil and smaller parts which may also be picked up can if desired be simultaneously screened.

A drawback of such separate tools is that they must be all be taken along each time to enable the different operations to be performed, take up a relatively large amount of storage space and require a relatively high investment. In order to obviate these drawbacks, different multi-functional tools combining two or more functions have been developed. Without exception however, these known multi-functional tools detract from the convenience of use and ergonomics. In addition, there are gardening tools with a handle and a working member, wherein the working member can be exchanged with one or more different working members so as to fulfil different functions. Not only is such a solution found to be relatively expensive in practice, it also does not save the user from having to take along each time all possibly necessary, separate working members.

The present invention has for its object, among others, to provide a gardening tool of the type stated in the preamble which combines two or more functions without however detracting from the convenience of use and the ergonomics of the functions as such.

In order to achieve the intended object, a gardening tool of the type stated in the preamble has the feature according to the invention that the working member comprises a first blade-like part with which it is connected to the second outer end of the handle, that the working member comprises a second blade-like part with a number of at least substantially parallel tines lying in a blade plane, which second part extends from the first part, and that the first and second blade-like parts of the working member together enclose an obtuse angle. The working member herein comprises a tined second part with which a rake, screening and fork function can be performed, and in addition a first part upright relative thereto which contributes toward a shovel function of the whole. Because the first and second part are not at a right angle but at an obtuse angle relative to each other, raking, screening and shovelling can all be performed in a smooth, ergonomically sound movement, and the tool is in no way impeded in these basic functions.

In a preferred embodiment, a gardening tool according to the invention has the feature that, at least in a first working position, the blade plane of the tines of the second part is directed at least practically parallel to a ground surface, and in a second, reverse working position is positioned at least practically transversely of the ground surface. Such a changing position of the work-blade relative to the ground surface can be achieved by a careful adjustment of the mutual angle of the first and second part to the direction of the handle. In the first position the tool mainly performs the function of a shovel, screen and fork, while the second position is ideal for raking up loose material and levelling a ground surface. An ergonomically particularly sound tool with a multi-functional utility is thus provided.

A further particular embodiment of the gardening tool has the feature according to the invention that the first part comprises a handle insert as well as a number of connecting parts which extend and fan out therefrom and which maintain a certain mutual distance and end on their outer end in a continuous outer edge of the first part remote from the handle, wherein the tines of the second part of the working member extend from the outer edge of the first part. Owing to the gaps between the sheeting of the first part a certain screening function can also be performed herewith, while the sheeting nevertheless provides enough closed surface, particularly at their fanned-out outer end, to retain a sufficient shovelling function. A gardening tool according to the invention is more particularly characterized in this respect in that the first part of the working member is curved in at least substantially concave, at least hollow, manner toward the second part. The concave, at least hollow design of the first part of the working member increases the shovelling capacity, while furthermore a centre of gravity of a shovelled quantity of material hereby comes to lie closer to the second outer end of the handle, which reduces a moment exerted thereby and makes working with the tool lighter.

For the purpose of an improved shovelling function of the assembly, a further preferred embodiment of a gardening tool according to the invention is characterized in that the second part is flanked on either side by upright third parts over at least a part of its length, and that the second part and the third parts mutually enclose an obtuse angle. The two flanking, upright third parts prevent a shovelled-up quantity of material from being able to fall sideways from the tined blade all too easily, while their orientation relative to this blade provides a certain funnel function, whereby shovelled-up material is as it were automatically guided onto the tined blade. In a particular embodiment, a gardening tool according to the invention herein has the feature that the third parts comprise a tine which is elevated relative to an outer tine of the tines of the second part, and maintains at least practically the same distance therefrom as the tines of the second part on average relative to each other. This additional tine provides an extension of a screening function of the tined work-blade, while the elevated position also has a positive effect on the shovelling capacity of the assembly. A gardening tool according to the invention more particularly has the feature here that the third part comprises an at least practically closed upright portion which extends from the first part and reaches only partly along a length of the tine of the third part.

With a view to enhancing the convenience of use and the ergonomic aspects of the assembly, a further particular embodiment of a gardening tool according to the invention has the feature that the handgrip is directed at least substantially transversely of the handle, and more particularly that the handgrip comprises a D-grip. Such a transversely placed handgrip, and in particular a D-grip, provides on the one hand a feel and control in operations performed therewith, and furthermore facilitates a transition between the above stated first and second working positions of the tool.

A further contribution to the ergonomics and utility of the tool is made by a further preferred embodiment of a gardening tool according to the invention, which is characterized in that the handle comprises a downward bend in at least a first working position. This downward bend ensures that the first end of the handle is at an acceptable height, while the first part of the working member nevertheless stands relatively upright so as to enhance the shovelling capacity and function.

In order to enhance shovelling of loose material from a flat ground surface, in particular a terrace or paving, a further particular embodiment of a gardening tool according to the invention has the feature that the tines narrow at least on a free outer end thereof and are flat on an underside. The relatively thin, narrowed ends of the tines pass more easily beneath a quantity of loose material to be shovelled up, while the flat underside conforms optimally with a likewise flat ground surface. According to the invention a gardening tool more particularly has the feature herein that on an upper side thereof the outer end is a straight continuation of at least an adjacent part of the tine. The tined work-blade thus has a particularly regular and flat structure on an upper side thereof. A further particular embodiment of a gardening tool according to the invention has in this respect the feature that the tines have an at least substantially cylindrical shape over at least a basic part of their length with a diameter lying between 5 and 15 millimetres. The cylindrical shape, together with the diameter thereof, herein contributes toward a sufficient bending strength of the tines.

Particularly good results have been achieved in practice with a further particular embodiment of a gardening tool according to the invention, which is characterized in that the second blade-like part of the working member comprises between 6 and 40 tines, in particular between 14 and 20 tines. Such a number of tines, which is relatively large for a fork, provides an effective screening and raking function, while shovelling is nevertheless possible. An embodiment of a gardening tool according to the invention is more particularly characterized here in that the tines thereof maintain an average mutual distance of 10-35 millimetres, in particular of 15-27.5 millimetres.

In a further particular embodiment, a gardening tool according to the invention has the feature that a length of the tines of the second part increases from the outside to the inside from 40-240 millimetres for an outermost tine to 120-400 millimetres for an innermost tine, and that free outer ends of the tines lie in an at least practically straight line. A front side of the tining is thus straight, while a rear side lies gradually deeper so as to be able to receive more shovelled-up material.

In order to reduce the production costs and to make the tool suitable for series production, a further preferred embodiment of a gardening tool according to the invention has the feature that the working member is formed integrally. The working member thus requires no further assembly of components and can be manufactured in a single production step. With a view to this latter, a further preferred embodiment of a gardening tool according to the invention has the feature that the working member is composed of plastic or metal, in particular of an impact-resistant and break-resistant, yet sufficiently flexible plastic from a group of optionally fibre-reinforced polycarbonate, polyamide, polypropylene and ABS, which enables particularly economic manufacture of the working member by means of for instance (injection) moulding or machining. The same applies for the handgrip of the gardening tool in a further particular embodiment, which according to the invention is characterized in that the handgrip is formed from one part in plastic, in particular from an impact-resistant and break-resistant plastic from a group of polypropylene and ABS.

In order to achieve a light total weight of the assembly while sufficient strength is nevertheless provided, a further particular embodiment of a gardening tool according to the invention has the feature that the handle comprises a relatively lightweight, optionally filled, metal tubular body, particularly of aluminium or thin-walled steel.

The invention will now be further elucidated on the basis of an exemplary embodiment and an accompanying drawing. In the drawing:

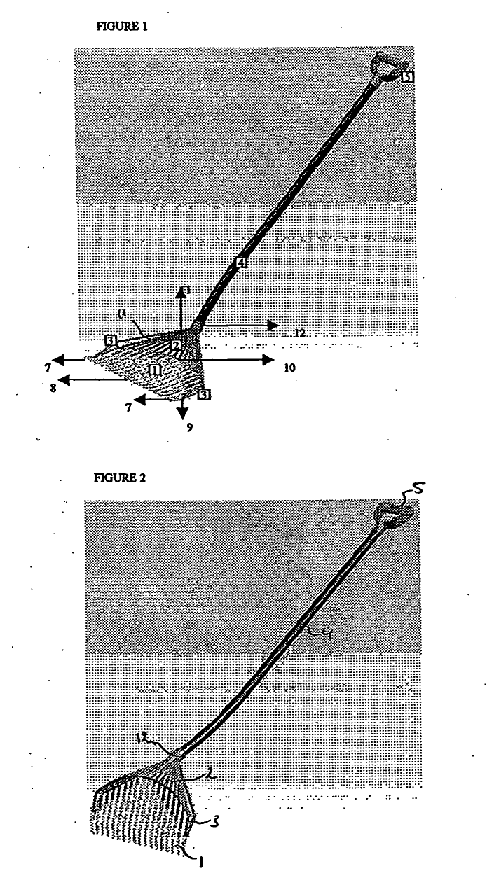

FIG. 1 shows a perspective view of a first exemplary embodiment of a gardening tool according to the invention in a first working position;

FIG. 2 is a perspective view of the gardening tool of FIG. 1 in a second working position;

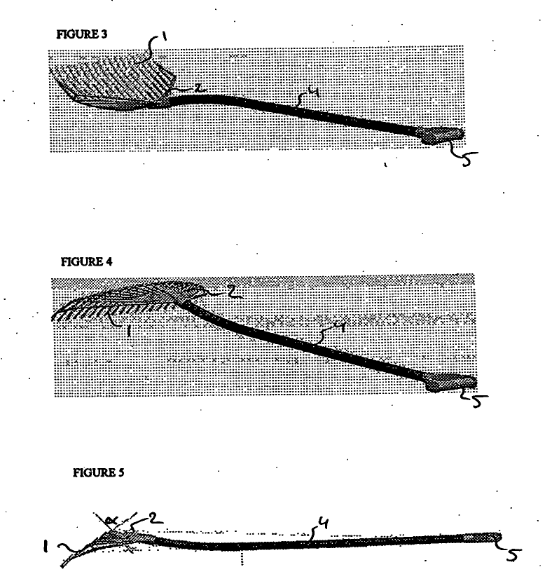

FIGS. 3-4 show perspective views of the gardening tool of FIG. 1 in different working positions;

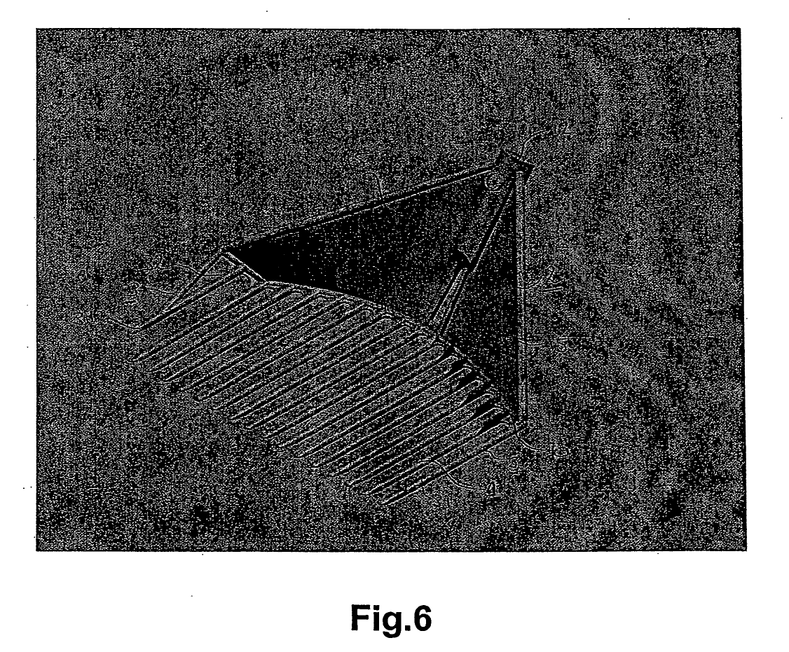

FIG. 5 shows angles enclosed by different parts of the tool of FIG. 1 by means of construction lines; and

FIG. 6 shows a working member of a second exemplary embodiment of a gardening tool according to the invention.

It is otherwise noted that the figures are shown for the most part schematically and not to the same scale. Some dimensions in particular may be exaggerated to a greater or lesser extent for the sake of clarity. Corresponding components are designated as far as possible in the figures by corresponding reference numerals.

The gardening tool shown in FIG. 1 comprises a handle 4, typically 115-175 centimetres long, with a handgrip 5 on a first outer end and a working member 1,2 on a second outer end. Although the handgrip can also form an integral part of the handle, use is made in this embodiment of handgrip transversely of the handle in the form of an integrally manufactured D-grip of an impact-resistant and break-resistant plastic such as polypropylene and ABS. The working member is likewise manufactured integrally, wherein an impact-resistant and break-resistant, yet sufficiently flexible plastic such as optionally fibre-reinforced polycarbonate, polyamide, polypropylene or ABS is applied. Both parts 1,5 can thus be manufactured in a single production step relatively inexpensively and allowing series production by means of for instance injection moulding. With a view to the desired rigidity and strength at a relatively low weight, a thin-walled metal tubular body of aluminium or steel is used for handle 4. The handle preferably comprises a slight curve, which is shown in FIG. 1 in a descending or downward-directed orientation, in order to facilitate a shovelling function with the working member. In combination with the specific angular design of the working member, this curve furthermore ensures that, in the reverse position of the tool shown in FIG. 2, the outer end of work-blade 1 is directed at least substantially transversely of a ground surface so as to thus facilitate a raking function of the tool.

The working member comprises a blade-like first part 2 which comprises a handle insert 12, by means of which the handle 4 is connected reliably to the working member. The first part 2 forms a rear section of the working member and comprises, in addition to handle insert 12, a number of fanning-out connecting parts extending therefrom in the form of 16 to 20 spokes or sheets 11, which end in a continuous outer edge 10, remote from handle 4, of the first part 2 of the working member. If desired, fewer or more of such sheets or spokes can be applied, and their mutual distance varied. As can be seen in the figure, and is manifest in the progression of outer edge 10, the first part 2 of the working member takes a concave form in this embodiment.

The working member further comprises a blade-like second part 1 which forms a tined front section. The front section typically comprises 6 to 20 tines which lie in a plane substantially parallel to each other and extend from the outer edge of the first part. The tines herein maintain a fixed mutual distance of 10-35 millimetres, in particular 15-27.5 millimetres, and have a thickness of 5-15 millimetres. In the shown embodiment the front section comprises 16 such tines with an average mutual distance of about 13 millimetres and a thickness of about 8-10 millimetres. The mutual pitch of the tines thus amounts to an average of about 22 millimetres in this embodiment. A length of the tines in front section 1 varies in accordance with the curve of outer edge 10 of the first part, such that the free outer ends thereof lie in a straight line. In this embodiment this means that the length of the tines increases from the outside to the inside from about 40-240 millimetres for the outermost tines to 120-400 millimetres for the most centrally located tines, this in accordance with the length to be bridged between outer edge 10 of the first part 2 and the straight end of the second part 1. On their underside the tines of the front section are flattened or slightly angled over a distance of about 50 to 120 millimetres from a front side of the front section. On their free outer end the tines are shaped by grinding and thus become narrower, while on their underside they are flat and on their top side a straight continuation of the other part of the tine.

The front section of the working member is flanked by two upright third parts 3 which enclose an obtuse angle with the blade-like, tined second part 1. Both third parts 3 laterally form an upright portion, which increases the shovelling capacity of the working member and moreover guides shovelled-up material to the tined front section in the manner of a funnel. As is more readily apparent in FIG. 6, the third parts both comprise a tine 31 which is slightly elevated relative to the blade and which is formed by the tines of front section 1. This tine is moreover slightly shorter, but otherwise maintains practically the same distance from the adjacent tine of the front section as the tines of the front section relative to each other. In addition, the elevated third parts 3 comprise a substantially triangular, optionally closed part 32 which extends from the rear section 1 of the member but only reaches over a part of the length of tine 31.

According to the invention the first and second part form an obtuse angle relative to each other, which is further indicated with lines in FIG. 5. Owing to this relative orientation of these two parts, there is obtained, in combination with the handle, a particularly ergonomic gardening tool which, in its position shown in FIG. 1, functions especially as shovel for collecting and shovelling up loose material such as garden and leaf waste, see also FIG. 3, while in a reverse position of FIGS. 2 and 4 it can be used for raking, or raking together or sweeping. The tool according to the invention is therefore multi-functional, without this detracting at all from its functionality, convenience of use and ergonomics in any of its functions.

FIG. 6 shows a second exemplary embodiment of a gardening tool according to the invention. Because the tool is otherwise the same as that of FIG. 1, only the working member is shown here. The working member here also comprises a concave curved, blade-like first part 2 with a handle insert 12 and a blade-like second part 1 which extends therefrom and is provided with a tining. Other than in the above described exemplary embodiment, a rear section of the working member is in this case practically closed by two sheeting parts 15 which extend from handle insert 12 to an outer edge 10 of the first part and form practically the entire rear section. Such a closed form provides an improved shovelling function, particularly for small, loose material. As in the first exemplary embodiment, the tines are of practically cylindrical shape with a diameter or thickness of 5-15 millimetres, and the tines narrow on their free outer end with a flat bottom surface. In this embodiment the front section 1 also comprises third parts on either side in the form of raised flanks 3, which in this case take a closed form. The two flanks 3 and the first part 2 of the working member form an obtuse angle with the blade formed by the tines of the second part 1.

Although the invention has been further elucidated above on the basis of only two exemplary embodiments, it will be apparent that the invention is by no means limited thereto. On the contrary, many other variations and embodiments are possible within the scope of the invention for a person with ordinary skill in the art. Although in practice all the sizes, materials and dimensions given in the exemplary embodiments generally provide particularly good characteristics, they in no way preclude differing sizes, materials and dimensions. Instead of a hollow handle, a filled handle or a handle with a solid core can also be used for an increased rigidity and strength. Wood is also suitable as material therefor instead of metal or plastic. If desired, the handle can also be straight.

The first part of the working member can be closed to a greater or lesser degree so as to enhance a shovelling function thereof, or be given a more open form to enhance a screening function, this in accordance with an actual need. In particular it is possible to give this part of the working member a completely closed form, wherein a concave progression is preferably maintained.

The invention generally provides a multi-functional tool which is particularly ergonomic and user-friendly in all its functions.

1. Gardening tool comprising a handle with a handgrip on a first outer end and a working member on a second outer end, characterized in that the working member comprises a first blade-like part with which it is connected to the second outer end of the handle, that the working member comprises a second blade-like part with a number of at least substantially parallel tines lying in a blade plane, which second part extends from the first part, and that the first and second blade-like parts of the working member together enclose an obtuse angle.

2. Gardening tool as claimed in claim 1, characterized in that, at least in a first working position, the blade plane of the tines of the second part is directed at least practically parallel to a ground surface, and in a second, reverse working position is positioned at least practically transversely of the ground surface.

3. Gardening tool as claimed in claim 1, characterized in that the first part comprises a handle insert as well as a number of connecting parts which extend and fan out therefrom and which maintain a certain mutual distance and end on their outer end in a continuous outer edge of the first part remote from the handle, wherein the tines of the second part of the working member extend from the outer edge of the first part.

4. Gardening tool as claimed in claim 3, characterized in that the first part of the working member is curved in at least substantially concave, at least hollow, manner toward the second part.

5. Gardening tool as claimed in claim 1, characterized in that the second part is flanked on either side by upright third parts over at least a part of its length, and that the second part and the third parts mutually enclose an obtuse angle.

6. Gardening tool as claimed in claim 5, characterized in that the third parts comprise a tine which is elevated relative to an outer tine of the tines of the second part, and maintains at least practically the same distance therefrom as the tines of the second part on average relative to each other.

7. Gardening tool as claimed in claim 6, characterized in that the third part comprises an at least practically closed upright portion which extends from the first part and reaches only partly along a length of the tine of the third part.

8. Gardening tool as claimed in claim 1, characterized in that the handgrip is directed at least substantially transversely of the handle.

9. Gardening tool as claimed in claim 8, characterized in that the handgrip comprises a D-grip.

10. Gardening tool as claimed in claim 1, characterized in that the handle comprises a downward bend in at least a first working position.

11. Gardening tool as claimed in claim 1, characterized in that the tines narrow at least on a free outer end thereof and are flat on an underside.

12. Gardening tool as claimed in claim 11, characterized in that on an upper side thereof the outer end is a straight continuation of at least an adjacent part of the tine.

13. Gardening tool as claimed in claim 1, characterized in that the second blade-like part of the working member comprises between 6 and 40 tines, in particular between 14 and 20 tines.

14. Gardening tool as claimed in claim 1, characterized in that the tines thereof maintain an average fixed mutual distance of 10-35 millimetres, in particular of 15-27.5 millimetres.

15. Gardening tool as claimed in claim 1, characterized in that the tines have an at least substantially cylindrical shape over at least a basic part of their length with a diameter lying between 5 and 15 millimetres.

16. Gardening tool as claimed in claim 1, characterized in that a length of the tines of the second part increases from the outside to the inside from 40-240 millimetres for an outermost tine to 120-400 millimetres for an innermost tine, and that free
